(19) United States
(12) Patent Application Publication
(10) Pub. No.: US 2009/0132428 A1
(43) Pub. Date: May 21, 2009

(54) Method for creating and marketing a modifiable debt product

(76) Inventors: Stephen Jeffrey Wolf, Great Neck, NY (US); Anthony Albert Fraind, New York, NY (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/274,074

(22) Filed: Nov. 15, 2005

Related U.S. Application Data
(60) Provisional application No. 60/628,079, filed on Nov. 15, 2004.

(51) Int. Cl. G06Q 40/00

(52) U.S. Cl. 705/36 R; 705/37

(57) ABSTRACT

This invention relates to a method for creating and marketing a modifiable debt product wherein a debtor who issues the debt note has the ability to modify the type of the note coupon multiple times throughout the life of the note while continuously providing fixed coupons to respective investors. The modifications to the note coupon are determined by prevailing market conditions and are executed as on-market transformations. The invention provides flexibility to the debtor who may wish to change the note in response to the fluctuations of the market without creating additional risk to investors.

### CROSS-REFERENCE TO RELATED APPLICATION

This application claims the benefit of U.S. Provisional Application No. 60/628,079 filed Nov. 15, 2004, the entire disclosure of which is hereby incorporated herein by reference.

### FIELD OF THE INVENTION

This invention relates to a method for creating and marketing a modifiable debt product, wherein the debtor has the ability to change the form of the note coupon during the life of the note with on-market transformations determined by prevailing market conditions.

### BACKGROUND OF THE INVENTION

Debt instruments are critical components of commerce, enterprise and investment. They are typically enforceable promises from a debtor to repay the principal of a loan plus a periodic payment (“coupon”) during the life of the loan. The repayment and/or the coupon may be secured by assets of the debtor, termed collateral. The coupon is often a payment of interest at a fixed rate or at a floating rate pegged to a preselected index.

Unfortunately, conventional debt instruments are needlessly inflexible with respect to the manner in which coupon payments are calculated (“coupon types”). Generally, once entered into, the coupon type is fixed, e.g. it is typically a fixed interest rate or a floating interest rate. While the certainty provided by a fixed coupon type is preferred by investors, it may be undesirable for a debtor dealing with an entirely different risk profile. For example, prevailing interest rate fluctuations may affect debtors differently than investors and may affect some debtors differently than other debtors. For sound economic reasons a debtor may wish to change from one type of coupon to another, e.g. to change from fixed interest rate to a floating rate or to a floating rate with a cap. But what is to the advantage of the debtor is often, at the same time, to the disadvantage of an unhedged investor, and investors typically are not hedged for such fluctuations. Investors may need the original interest note profile for their business needs—i.e. to fund liabilities. Accordingly there is a need for a new form of debt product that can provide debtors with the flexibility to change between coupon types while providing investors with a fixed coupon type.

### SUMMARY OF THE INVENTION

In accordance with the invention, a modifiable debt product comprises a debt instrument (referred to here as an “MDP Note” or “Note”) wherein the debtor has the ability to change the type of the coupon during the life of the Note. The debtor's MDP Note is held by a special purpose entity (“SPE”), such as a trust or a finance subsidiary of the issuer. The SPE enters into swap with a counterparty such as a bank to swap the MDP coupon for a conventional fixed coupon. The SPE then issues a non-modifiable fixed coupon debt instrument to investors.

Transformations between Note coupon types are advantageously carried out between the debtor and the SPE as on-market transformations determined by prevailing market conditions. Advantageously the MDP Note specifies the set of modifications available to the debtor and an agreed upon agent to calculate the terms for the on-market transformation. The coupon between the SPE and the investors remains unmodified. As a consequence the debtor obtains desired flexibility while the investors obtain a desired conventional coupon.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 is a schematic block diagram of the steps typically involved in creating, supporting and administering a modifiable debt product in accordance with the invention;

FIG. 2 is a block diagram illustrating financial transactions typically involved in implementing the steps of the FIG. 1 process.

### DETAILED DESCRIPTION

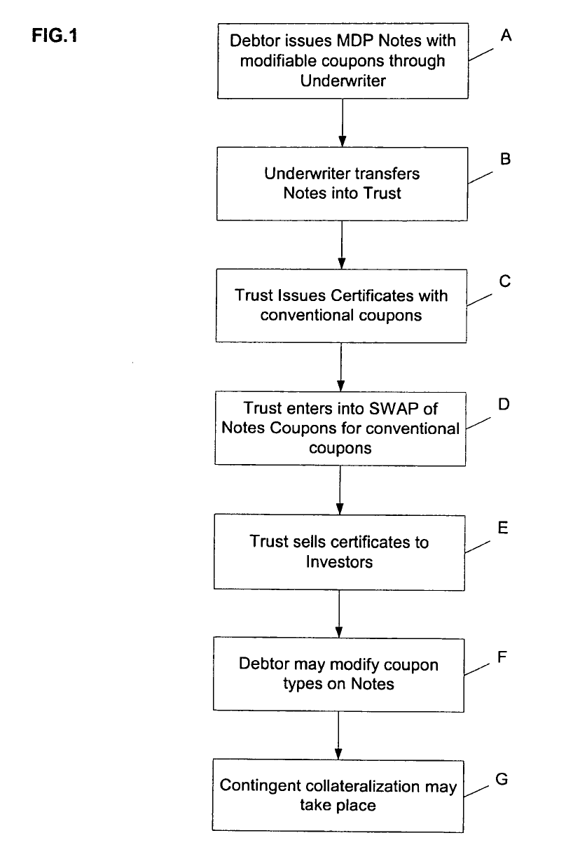

Referring to the drawings, FIG. 1 illustrates steps in the process of creating, supporting and administering a modifiable debt product. The steps need not be in the sequence illustrated, and some steps may be essentially simultaneous.

As shown in FIG. 1, an initial step at Block A is that a debtor client (hereinafter “Debtor”) of an Underwriter issues MDP Notes with modifiable coupons. The MDP Notes are debt instruments, typically having defined final maturities, and notably providing that the Debtor has the ability to change the coupon type on the Notes at least once during the life of the Notes. Change will be limited to selection among a set of predetermined coupon types which can be enumerated in the MDP Notes. Advantageously, the MDP Notes start out with a conventional coupon type such as a fixed or floating interest rate. The change preferably is an on-market transformation to be determined by prevailing market conditions, and advantageously, the change is effective only at specific times, e.g. on coupon dates.

In the next step (Block B) the Underwriter transfers the MDP Notes into a special purpose entity, such as a trust or finance subsidiary (hereinafter “Trust”). The MDP Notes are typically the bulk of the Trust's assets.

In the third step (Block C), the Trust issues beneficial interests (“trust certificates”) with conventional coupons, e.g. fixed-rate certificates. Preferably the trust certificates have a fixed or floating rate of interest comparable to the initial coupon of the MDP Notes, and advantageously, they have a final maturity comparable to the MDP notes.

In the next step (Block D), the Trust enters into a swap with a swap counterparty (referred to hereinafter as the “Bank”). The Bank swaps the MDP Note coupons, with their modification features, into conventional fixed rate coupons to pay the trust certificate coupons. By the swap, the Trust transfers to the Bank the risk that the modifiable coupons will not cover the conventional coupons that the Trust must pay out. The swap advantageously mirrors the form of the MDP Note to insure that the Trust will receive net coupons to meet its obligations to certificate holders. The trust coupon and the swap can be in US dollars or in foreign currency.

At about the same time (Block E), the Trust sells the trust certificates to Investors and pays the Underwriter for the MDP Notes. The Underwriter, in turn, pays the proceeds (less fees) to the Debtor client.

As shown in Block F, at one or more subsequent times the Debtor may change the coupon type of the MDP note. As stated above, the modification is preferably limited to a selection from a predetermined set of permissible coupon types. The permissible coupon types and the right of modification are preferably set forth in the MDP Note. The change in coupon is at current market conditions, taking into consideration the fair market value of the existing MDP Note coupon. The modification preferably is effected by the Debtor informing the Bank of the requested change. A Calculation Agent, which can be the Bank, calculates the terms required to ensure that the transformation conforms with prevailing market conditions.

As indicated in Block G of FIG. 1, it is advantageously provided in the pertinent agreements that certain contingent events can require credit enhancement through collateralization. If the market value of the MDP Note changes due to changes in the swap rates (not credit spreads) to a market value greater than the present value of the conventional note, then the Debtor may have to post collateral to the Trust in an amount commensurate with excess of the market value over the conventional note. This supports the Issuer's obligation to the Trust.

It is also contemplated that the contract between the Trust and the Bank is advantageously collateralized and bounded as follows:

1. The Trust will post collateral in the amount of the mark-to-market of the swap with the Bank, above a predefined threshold, and

2. The Bank will post collateral to the Trust in the amount that the Bank's negative mark-to-market on the swap exceeds a separate predefined threshold.

It is also advantageous to provide that if the credit rating of the Debtor is downgraded below investment grade (or a similar pre-agreed level), the downgrading terminates the swap and triggers an immediate unwind and payment of the swap. The MDP Note coupon will then revert to the conventional coupon that the Trust is paying to the Investors, and the Notes will not be distributed to Investors. The Trust then functions as a strict “passthrough”. Investors will have the right to call for a pro-rata distribution of the Trust's asset (primarily the Notes). The interest rate on the MDP Notes at this point will be the “market” interest rate for the debt at the time of the original execution.

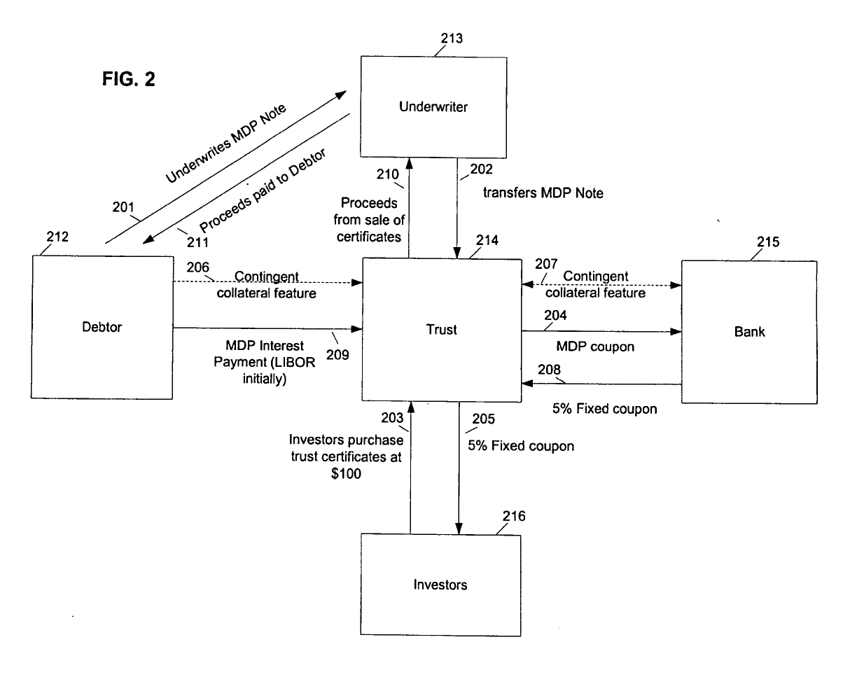

FIG. 2 is a schematic block diagram showing the participants and asset flows of a typical transaction. At 201, the Underwriter 213 underwrites the MDP Note with proceeds to be paid to the Debtor 212, at 211. At 202, the Underwriter 213 transfers the MDP Note to Trust 214 in return for proceeds to be paid from the sale of conventional coupon trust certificates (e.g. 5% fixed coupon certificates), at 210. At 203, Investors 216 purchase the trust certificates. The Debtor 212 pays the MDP Note coupon, which may, for example, start out as a fixed rate coupon, to the Trust 214, at 209. At 204, the Bank 215 swaps the conventional coupon at 208 for the MDP Note coupon at 204. At 205, the Trust 214 pays the conventional coupon to the Investors 216. The dotted lines at 206 and 207 indicate optional contingent collateral obligations. The trust certificates will be guaranteed by the Debtor as to principal and interest. The Trust can optionally issue a nominal amount of equity (e.g. $1000) to be purchased by the Debtor.

The invention can now be more clearly understood by consideration of the following specific examples.

### EXAMPLE 1

### Hypothetical Transaction—Creation and Marketing

1. Referring to FIG. 2, the Debtor 212 issues a $100 12-year fixed-rate MDP Note that is underwritten by the Underwriter 213, at 201.

2. Acting as agent on behalf of the Debtor 212, the Underwriter 213 transfers the MDP Note to a newly-formed Trust 214, at 202.

3. The Trust 214 remits $100 to the Underwriter 213, at 210, through its issuance of 5.00% fixed rate notes to Investors 216, at 203.

4. Concurrently with the transfer, the Trust 214 enters into a swap with the Bank 215 which transforms the MDP Note coupon into the 5.00% fixed coupon, referenced at 204 and 208, that the Trust 214 owes its Investors 216.

5. The 5.00% payment is made to the Investors 216 periodically throughout the life of the MDP Note, at 205.

6. The Debtor 212 has the right to change the coupon type of the MDP Note by selecting a new coupon type from a list of predetermined permissible coupon types.

### EXAMPLE 2

### MDP Note—Coupon Modification Provisions

The MDP note advantageously provides that the Debtor may inform the Bank of the Debtor's intent to change the form of the coupon of the MDP Note. The change in coupon is to be at market rates as of the time of change, taking into consideration the fair market value of the existing MDP Note coupon. Preferably payments under the MDP Note are bounded so that any embedded derivative within the Note does not violate bifurcation rules of the types set forth in SFAS 133 and SFAS 149. Advantageously, permissible coupon types may include one or more of the following alternatives. The term “LIBOR,” as known in the art, refers to an interest rate index known as the London Inter Bank Offering Rate. The term “USD” refers to payment in US dollars.

1. LIBOR. Issuer pays USD three month LIBOR plus/minus a spread. Additional features may include:
Arrears feature. The USD three month LIBOR is set at the end of the payment period as opposed to the typical LIBOR setting at the beginning of the period.
Knock-In Feature. Knock in feature calls for a fixed rate coupon or a capped floating rate coupon to become extant should a predetermined LIBOR knock-in level be breached.

2. Capped. Issuer pays USD three month LIBOR plus/minus a spread, subject to a cap. Additional features may include:
Knock-Out Feature. The cap ceases to exist if LIBOR is greater than a predetermined LIBOR reference level.
Knock-In Floor Feature. In addition the cap, if LIBOR is set below a certain predetermined LIBOR reference level, a LIBOR floor becomes activated, putting a minimum rate on the LIBOR that the Issuer pays on the MDP Note.

3. Floored. Issuer pays three month LIBOR plus/minus a spread, subject to a minimum Floor Rate.

4. Collared. Issuer pays three month LIBOR plus/minus a spread, subject to a maximum Cap Rate and a minimum Floor Rate.

5. Callable (to Fixed). Issuer pays three month LIBOR plus/minus a spread. Floating Rate automatically converts to a fixed rate if certain LIBOR or Swap Rate levels are reached.

6. Putable (to Fixed). Issuer pays three month LIBOR plus/minus a spread. Issuer further has the right to convert to Fixed at a predetermined Rate on certain pre-specified conversion dates.

7. Fixed. Issuer pays a fixed rate of interest on the MDP Note. Additional Feature:
Knockout Feature. The interest rate automatically converts to three month LIBOR plus/minus a spread if LIBOR breaches a predetermined Rate.

8. Callable+. Issuer pays a fixed rate of interest on the MDP Note. Issuer has the further right to convert the interest payments to three month LIBOR plus a predetermined spread on certain pre-specified conversion dates.

9. Putable+. Issuer pays a fixed rate of interest on the MDP Note. Fixed Rate automatically converts to a floating rate at three month LIBOR plus/minus a spread rate if certain LIBOR or Swap Rate levels are reached.

While the above examples use the three month LIBOR as a preselected index, other interest rate indices could be used. Moreover although the examples call for payment in US dollars, payments could be specified in currency other than U.S.

### EXAMPLE 3

### MDP Note—Typical Collateral Obligations

1. The Debtor will be required to post collateral in support of its obligation to the Trust if the Debtor's exposure on the MDP Note exceeds a predetermined amount or its credit quality falls below a predefined trigger. Exposure, in this context, refers to the difference between the current note cashflows and the contractual fixed Trust cashflows to investors, both evaluated at the LIBOR flat swap curve. The Bank will post collateral to the Trust under a similar arrangement.

2. If the Debtor is rated above or equal to a predefined credit rating trigger 1 and the exposure on the MDP Note is less than or equal to a predefined threshold, then the Debtor need post no collateral to the Trust in support of the Debtor's debt obligation. If the exposure is greater than the threshold, the Debtor must pledge cash or securities with a market value equal to at least a prescribed percentage of the exposure. Collateral may be called for on a periodic basis.

3. If the Debtor is rated below predefined credit rating trigger 1 but greater than or equal to a lower credit rating trigger 2, the Debtor must pledge cash or securities with a market value equal to at least a prescribed percentage of the exposure. Collateral may be called for on a periodic basis.

4. If the Debtor is rated below credit rating 2, a mandatory swap termination event occurs. In such event, the swap is terminated and collateral is held by the appropriate party. After swap termination payments have been made to/from the swap counterparty, any remaining collateral held by the Trust will revert to the Debtor. The MDP Notes revert to the fixed rate offered to the Investors. The modification feature of the MDP Notes is no longer active for the life of the Notes. The MDP Notes are not distributed to the Investors, but the Investors acquire rights for a pro-rata distribution of the Trust assets, and the Debtor continues to service the debt for the life of the Notes.

### EXAMPLE 4

### Hypothetical Transaction—Debtor Modifies Coupon

1) On Apr. 1, 2004, the Debtor issues a 5% fixed rate MDP Note with the option to alter the coupon.

2) On Jul. 1, 2004, the Debtor changes the 5% fixed rate coupon to a floating rate.

3) Three months later, the Debtor changes the form of the MDP Note to a “Callable+” structure with 2 year call lockout.

It can now be seen that one aspect of the invention is a method of creating and marketing a modifiable debt product having a modifiable coupon wherein the debtor has the ability to change the type of the coupon. In essence the method comprises the steps of issuing one or more modifiable debt instruments of the debtor that provide the modifiable coupon and forming a special purpose entity which holds the modifiable debt instruments. It further includes the steps of creating beneficial interests in the special purpose entity that pay a fixed coupon type, obtaining for the special purpose entity a swap of the modifiable coupon for the fixed coupon type and marketing the beneficial interests to investors.

In an exemplary embodiment, the debtor's ability to change the type of the coupon is limited to a selection from a predetermined group of coupon types. Advantageously, the debtor is able to select from one or more coupon types in the group consisting of LIBOR, Capped LIBOR, Floored LIBOR, Collared LIBOR, LIBOR Callable to Fixed, LIBOR Putable to Fixed, Knockout, Callable+and Putable+.

Preferably the change in the type of the coupon is an on-market transformation determined in accordance with prevailing market conditions. The terms of the transformation are advantageously calculated by a predesignated calculation agent. Additionally, the modification is effective only at specific times, preferably on coupon dates.

Another aspect of the invention from the viewpoint of the Trust is a method of financing a loan for a debtor wherein the debtor has the ability to change the coupon type. The method comprises the steps of receiving a note of the debtor providing a modifiable coupon whose type the debtor has the ability to change. The modifiable coupon of the note is swapped for a fixed coupon type, and beneficial interests are issued to one or more investors having a coupon of the fixed coupon type.

A third aspect of the invention is the trust arrangement providing investors with payments of a fixed coupon type. The product comprises a beneficial interest in a trust holding as assets one or more modifiable coupon notes wherein the debtor has the ability to change the type of coupon. The trust also holds a swap agreement providing for swapping the modifiable coupons to coupons of the fixed coupon type.

And a fourth aspect of the invention is the modifiable debt product comprising the MDP Note wherein the debtor has the ability to change the coupon type during the life of the Note with on-market transformations based on prevailing market conditions. The Note can limit the debtors ability to change the type of coupon to a selection from predetermined coupon types. It can further provide that the on-market transformations be calculated by a designated agent.

It is to be understood that the above-described embodiments are illustrative of only a few of the many possible specific embodiments that can represent applications of the invention. Numerous and varied similar arrangements can be devised by those skilled in the art without departing from the spirit and scope of the invention.

1. A computer implemented method of creating and marketing a modifiable debt product having a coupon wherein a debtor has the ability to change the type of the coupon comprising the steps of:
issuing one or more modifiable debt instruments of the debtor that provide a moditiable coupon that the debtor can modify after the issuing of the debt instruments;
forming a special purpose entity which holds the modifiable debt instruments;
creating beneficial interests in the special purpose entity that pay a fixed coupon type;
obtaining for the special purpose entity a swap of the modifiable coupon for the fixed coupon type; and
marketing the beneficial interests to investors.

2. The method of claim 1, wherein the debtor's ability to change the type of the coupon is limited to selection from a predetermined group of coupon types.

3. The method of claim 1, wherein the debtor's ability to change the type of the coupon comprises the ability to select from one or more of the coupon types from a group consisting of fixed LIBOR, floating LIBOR, capped LIBOR, floored LIBOR, collared LIBOR, callable to fixed LIBOR, putable to fixed LIBOR, callable plus, putable plus, and fixed note with conversion feature.

4. The method of claim 1, wherein the change in the type of the coupon is an on-market transformation determined in accordance with prevailing market conditions.

5. The method of claim 4, wherein the terms of the on-market transformation are calculated by a designated calculation agent.

6. The method of claim 1, wherein the ability of the debtor to change the type of the coupon is exercisable only on specific dates.

7. The method of claim 1, wherein the swap of the modifiable coupon to the special purpose entity is for currency other than US dollars.

8. The method of claim 1, further comprising promising to post collateral to the special purpose entity in support of the swap obligation, wherein said promise is based upon predefined conditions.

9. The method of claim 1, further comprising receiving an obligation from the special purpose entity to post collateral in support of its swap obligations.

10. The method of claim 1, wherein the debtor is obligated to post collateral in the event of a downgrading of the debtor's credit rating below a designated level.

11. A method of financing a loan for a debtor wherein the debtor has the ability to change the type of the coupon in a note for a debt, the method comprising the steps of:
receiving a note of the debtor providing a modifiable coupon whose type the debtor has the ability to change;
swapping the modifiable coupon for a fixed coupon type; and,
issuing to an investor a note having a coupon of the fixed coupon type.

12. The method of claim 11, wherein the debtor's ability to change the type of the coupon is limited to selection from a predetermined group of coupon types.

13. The method of claim 11, wherein the debtor's ability to change the type of the coupon comprises the ability to select from one or more of the coupon types from a group consisting of fixed LIBOR, floating LIBOR, capped LIBOR, floored LIBOR, collared LIBOR, callable to fixed LIBOR, putable to fixed LIBOR, callable plus, putable plus, and fixed note with conversion feature.

14. The method of claim 11, wherein the change in the type of the coupon is an on-market transformation determined in accordance with prevailing market conditions.

15. The method of claim 14, wherein the terms of the on-market transformation are calculated by a predesignated calculation agent.

16. The method of claim 11, wherein the ability of the debtor to change the type of the coupon is exercisable only on specific dates.

17. The method of claim 11, wherein the swap of the modifiable coupon is for currency other than US dollars.

18. The method of claim 11, further comprising promising to post collateral in support of the swap obligation, wherein said promise is based upon predefined conditions.

19. The method of claim 11, further comprising receiving an obligation from a second party to the swap to post collateral in support of its swap obligations.

20. The method of claim 11, wherein the debtor is obligated to post collateral in the event of a downgrading of the debtor's credit rating below a designated level.

21. An income product for providing investors with payments of a fixed coupon type comprising a beneficial interest in a trust, wherein the trust holds as assets one or more modifiable coupon notes, wherein a debtor has the ability to change the type of coupon, and wherein the trust also holds a swap agreement providing for swapping the modifiable coupons to the fixed coupon type.

22. The product of claim 21, wherein the debtor's ability to change the type of the coupon is limited to selection from a predetermined group of coupon types.

23. The product of claim 21, wherein the debtor's ability to change the type of the coupon comprises the ability to select from one or more of the coupon types from the group consisting of fixed LIBOR, floating LIBOR, capped LIBOR, floored LIBOR, collared LIBOR, callable to fixed LIBOR, putable to fixed LIBOR, callable plus, putable plus, and fixed note with conversion feature.

24. The product of claim 21, wherein the change in the type of the coupon is an on-market transformation determined in accordance with prevailing market conditions.

25. The product of claim 24, wherein the terms of the on-market transformation are calculated by a predesignated calculation agent.

26. The product of claim 21, wherein the ability of the debtor to change the type of the coupon is exercisable only on specific dates.

27. The product of claim 21, wherein the swap to the trust is for currency other than US dollars.

28. The product of claim 21, further comprising promising to post collateral to the trust in support of the swap obligation, wherein said promise is based upon predefined conditions.

29. The product of claim 21, further comprising receiving an obligation from the trust to post collateral in support of its swap obligations.

30. The product of claim 21, wherein the debtor is obligated to post collateral in the event of a downgrading of the debtor's credit rating below a designated level.

31. A modifiable debt product comprising a note between a debtor and a lender wherein the debtor has the ability to change the note coupon type during the life of the note with on-market transformations, the note limiting the debtor's ability to change the types of the coupon to selection from a predetermined group of coupon types; and the note providing the change in coupon types to be an on-market transformation determined in accordance with prevailing market conditions.

32. The debt product of claim 31, wherein the on-market transformations are calculated be a predesignated calculation agent.

33. The debt product of claim 31, wherein the ability of the debtor to change the type of coupon is effective only on specific dates.

34. The debt product of claim 31, wherein the ability of the debtor to change the type of coupon comprises the ability to select from one or more of the group consisting of fixed LIBOR, floating LIBOR, capped LIBOR, floored LIBOR, collared LIBOR, callable to fixed LIBOR, putable to fixed LIBOR, callable plus, putable plus, and fixed note with conversion feature.
